(19) United States
(12) Patent Application Publication
(10) Pub. No.: US 2008/0091916 A1
(43) Pub. Date: Apr. 17, 2008

(54) METHODS FOR DATA CAPACITY EXPANSION AND DATA STORAGE SYSTEMS

(75) Inventor: Ebrahim HASHEMI, Los Gatos, CA (US)

Correspondence Address: DUANE MORRIS LLP;IP DEPARTMENT (AGERE), 30 SOUTH 17TH STREET, PHILADELPHIA, PA, 19103-4196, US

(73) Assignee: Agere Systems, Inc., Allentown, PA (US)

(21) Appl. No.: 11/873,498

(22) Filed: Oct. 17, 2007

Related U.S. Application Data
(60) Provisional application No. 60/829,757, filed on Oct. 17, 2006.

(51) Int. Cl. G06F 12/06

(52) U.S. Cl. 711/209; 711/E12.082

(57) ABSTRACT

A data storage system includes at least one first storage device and at least one second storage device, and a storage controller coupled to the first storage device and the second storage device. The storage controller is configured to emulate a virtual storage device by grouping the first storage device and the second storage device. Each of the first storage device and the second storage device includes a plurality of blocks for storing data. The storage controller is also configured to expand a capacity of the virtual storage device by adding at least one third storage device to the first storage device. Each block of the third storage device has a 0 or 1 formatted in it, and a capacity of the virtual storage device is increased by a capacity of the third storage device.

This application claims the benefit of U.S. Provisional Patent Application 60/829,757, filed Oct. 17, 2006, which is incorporated by reference herein in its entirety.

### BACKGROUND

1. Field of the Invention

The present invention relates to data storage methods and data storage systems.

2. Description of the Related Art

Speed and storage capacity of computer systems, such as personal computers (PCs) or network computers, have been continuously and systematically improved. The speed of computer systems can be enhanced, for example, by high speed processors, devices or circuits. Traditionally, data are stored on magnetic disks, memories, such as dynamic random access memories (DRAMs), static random access memories (SRAMs) or Flash memories, magnetic tapes or other data storage devices that are configured in or coupled to computer systems to be accessed thereby. In order to achieve high-speed performance of computer systems, parallel storage devices have been configured in an array and coupled to respective controllers. The array of storage devices increases the storage capacity of a computer system, and the individual controller coupled to the corresponding storage device enhances speed of data transfer into and from the storage device. Thus, an array of storage devices provides high storage capacity and satisfies the high-speed data transfer that is desired for a computer system. (See, e.g., Patterson, et al., “A case for Redundant Arrays of Inexpensive Disks (RAID)”, Proceedings of the 1988 ACM-SIGMOD Conference on Management of Data, Chicago, Ill. pp 109-116, June 1988).

Nevertheless, using the array of storage devices described above increases the failure rate of the storage system due to the failure of one of the storage devices. This situation becomes worse when more storage devices are assembled as a storage system. To reduce the failure rate of the memory array, extra disks with redundant data and spare portions may be added to the storage system. If one storage device of the storage system fails, the data stored in the failed storage device can be recovered and stored in the spare portions of the extra disks. The storage system including the extra disk is designated as a redundant array of inexpensive disk (RAID). There are various RAID levels. For example, RAID 4 uses block-level striping with a parity disk. (See, e.g., Patterson, cited above, on pages 113-114). In other systems, such as RAID 5 and RAID 6, block-level striping is used with parity data distributed across all storage devices.

A process for expanding a RAID system by adding one or more expansion devices usually involves reading data and parity from old, narrow stripes and re-striping the data and parity, usually involving recalculating and positioning the new parity, into new, wide stripes. This process is generally referred to as reconfiguration or initialization. For some computer systems, this reconfiguration or initialization process will make the entire RAID system unavailable or non-accessible while this process is in progress. For some other computer systems, all of the blocks of the RAID system are accessible during the reconfiguration process, except for segments of the RAID system that are in transformation states. The reconfiguration or initialization of a RAID system takes time. For example, a RAID system having 200 gigabyte (GB) drives with 20 megabytes/sec sustained write bandwidth will require at least 10,000 seconds to finish the initialization process, during which the RAID system cannot be accessed.

To solve this problem, a bitmap associated with the expanded RAID system has been used for the instant expansion of the RAID system without waiting for reconfiguration or initialization. The bitmap shows which part of the RAID system has been initialized or reconfigured and which part of the RAID system has not been yet. The process of initialization and/or reconfiguration is spread out over time and probably in conjunction with an update of data. However, during the process the bitmap that has to be updated should be protected against data corruption in case of power failure.

U.S. Patent Application Publication No. 2005/0132135 provides a method associated with capacity expansion of a RAID system, the entirety of which is hereby incorporated by reference herein. The RAID system includes M number of storage devices, each of the storage devices having N number of data blocks. The data blocks, for example, are sequentially configured with a RAID 5 combination architecture. The method of expanding the RAID system includes disposing an expansion storage device in front of the M storage devices. The data blocks (except the parity data blocks) are sequentially moved to the new data blocks. The position of the new parity data blocks is the same as the position of the original parity data blocks.

From the foregoing, improved storage systems and methods are desired.

### BRIEF DESCRIPTION OF THE DRAWINGS

The present invention will be better understood from the following detailed description of the preferred embodiments of the invention that is provided in connection with the accompanying drawings.

Following are brief descriptions of exemplary drawings. They are mere exemplary embodiments and the scope of the present invention should not be limited thereto.

FIG. 1 is a schematic drawing showing an exemplary software stack.

FIG. 2 is a schematic block diagram of an exemplary system.

FIG. 3 is a schematic drawing showing an exemplary method for expanding a capacity of a virtual storage device.

FIG. 4A-4B are schematic drawings illustrating another exemplary method for expanding a capacity of a virtual storage device.

FIG. 5 is an exemplary block diagram of a method for expanding a capacity of a virtual storage device.

FIG. 6 is another exemplary block diagram of a method for expanding a capacity of a virtual storage device.

### DESCRIPTION OF THE PREFERRED EMBODIMENT

In accordance with some exemplary embodiments, a data storage system includes at least one first storage device and at least one second storage device, and a storage controller coupled to the first storage device and the second storage device. The storage controller is configured to emulate a virtual storage device by grouping the first storage device and the second storage device. Each of the first storage device and the second storage device includes a plurality of blocks for storing data. The storage controller is also configured to expand a capacity of the virtual storage device by adding at least one third storage device to the first storage device. Each block of the third storage device has a 0 or 1 formatted in it, and a capacity of the virtual storage device is increased by a capacity of the third storage device.

In accordance with some exemplary embodiments, a system comprises a host system and a data storage system. The data storage system is coupled to the host system. The data storage system comprises at least one first storage device and at least one second storage device, and a storage controller coupled to the first storage device and the second storage device. The storage controller is configured to emulate a virtual storage device by grouping the first storage device and the second storage device. Each of the first storage device and the second storage device comprises a plurality of blocks for storing data. The storage controller is also configured to expand a capacity of the virtual storage device by adding at least one third storage device to the first storage device. Each block of the third storage device has 0 or 1 formatted therein, and a capacity of the virtual storage device is increased by a capacity of the third storage device.

In accordance with some exemplary embodiments a method comprises emulating a virtual storage device by grouping at least one first storage device and at least one second storage device. Each of the first storage device and the second storage device comprises a plurality of blocks for storing data. A capacity of the virtual storage device is expanded by adding at least one third storage device to the first storage device. Each block of the third storage device has 0 or 1 formatted therein, and a capacity of the virtual storage device is increased by a capacity of the third storage device.

This description of the exemplary embodiments is intended to be read in connection with the accompanying drawings, which are to be considered part of the entire written description. In the description, relative terms such as “lower,” “upper,” “horizontal,” “vertical,” “above,” “below,” “up,” “down,” “top” and “bottom” as well as derivatives thereof (e.g., “horizontally,” “downwardly,” “upwardly,” etc.) should be construed to refer to the orientation as then described or as shown in the drawing under discussion. These relative terms are for convenience of description and do not require that the apparatus be constructed or operated in a particular orientation.

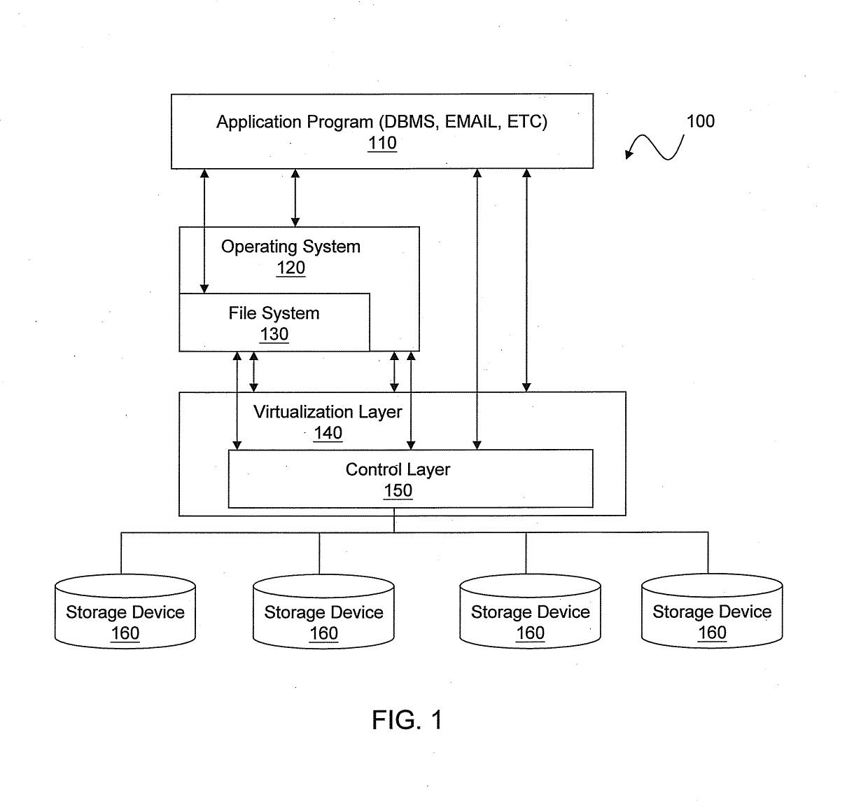

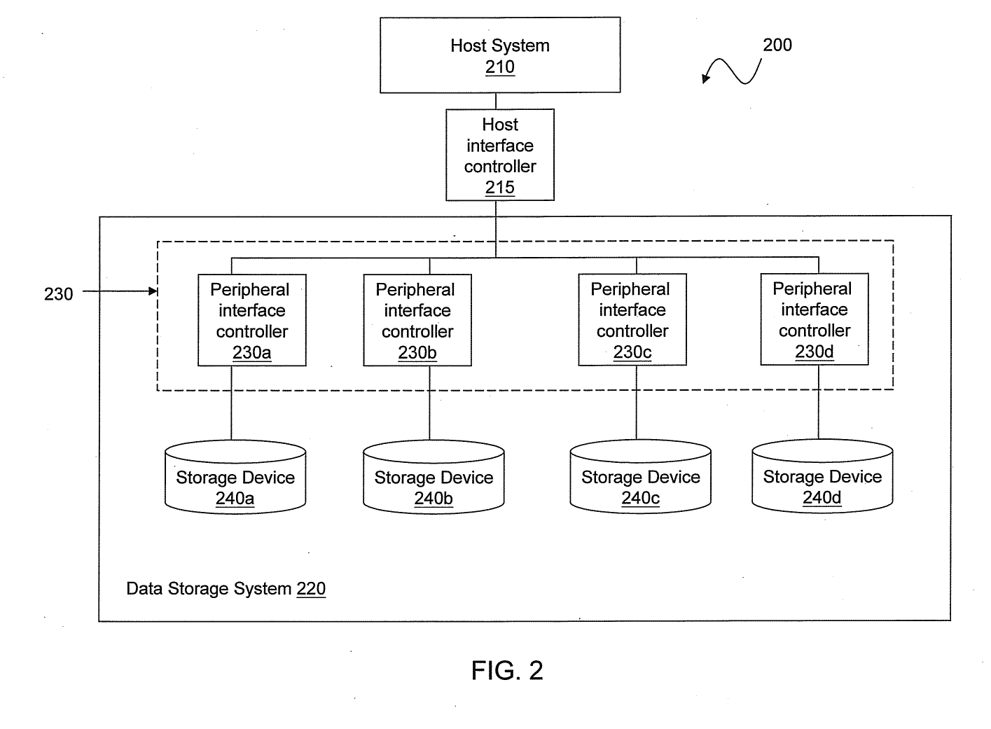

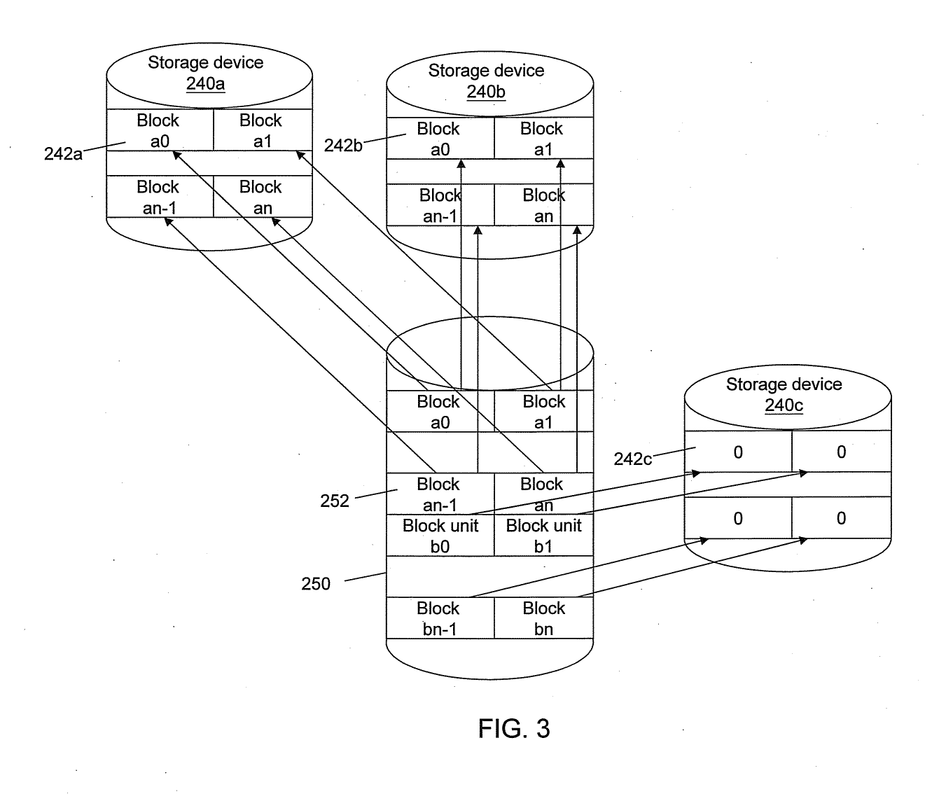

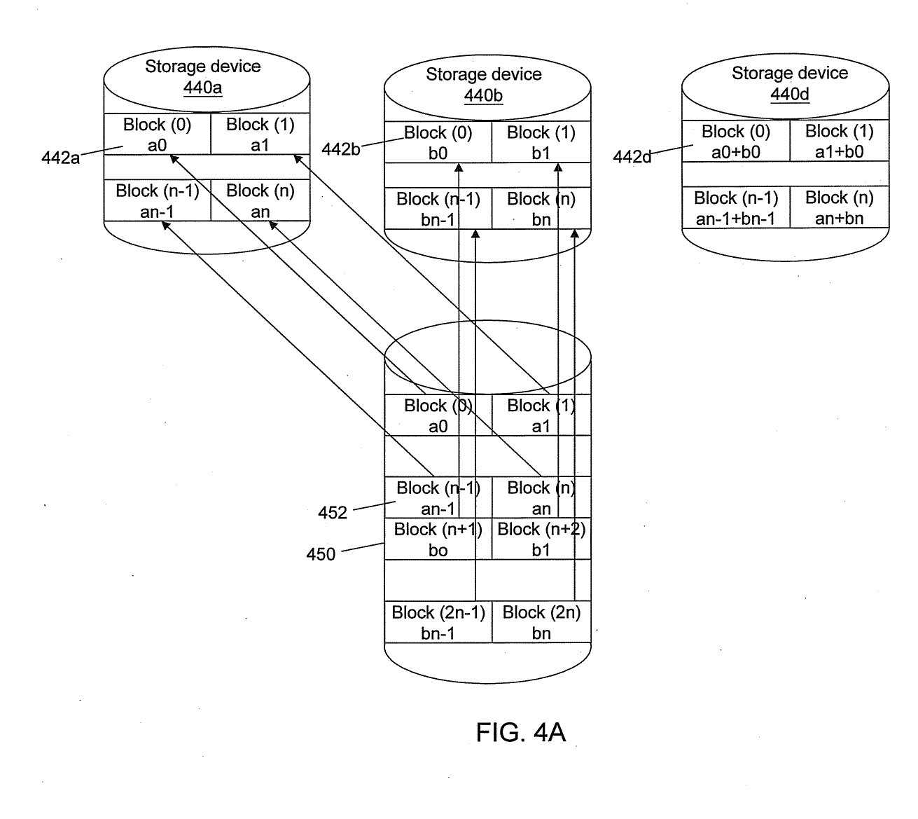

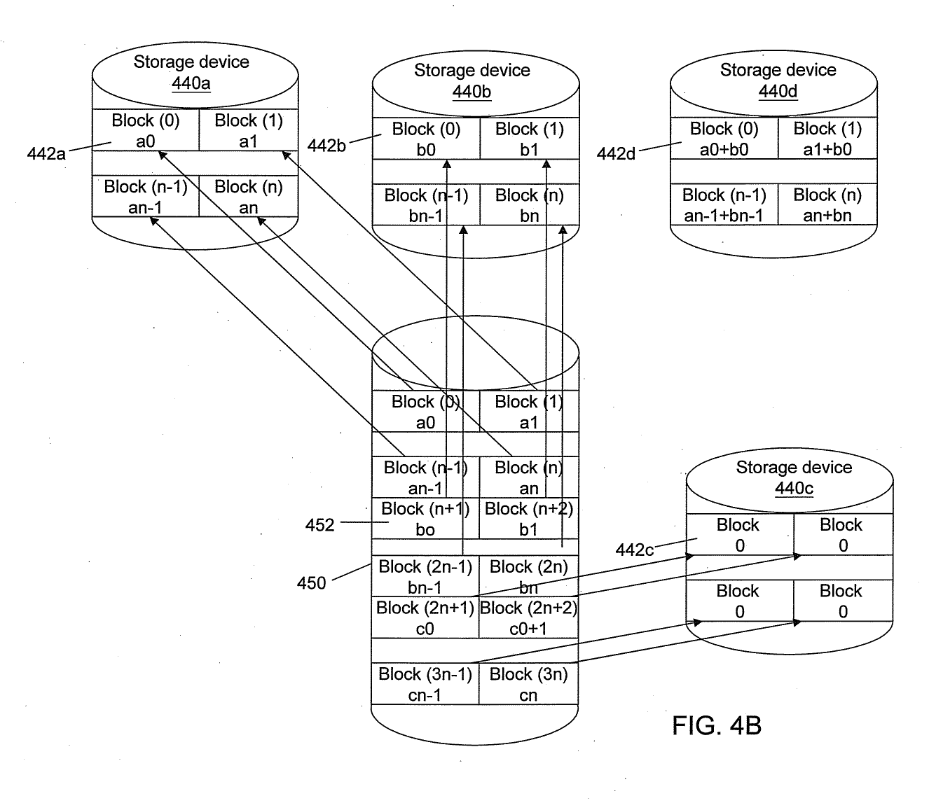

FIG. 1 is a schematic drawing showing an exemplary system. The system 100 comprises an application program 110, an operating system 120, at least one file system 130 and a virtualization layer 140 including a control layer 150 therein. In some embodiments, the control layer 150 may comprise a virtual storage device 250 or 450 (shown in FIGS. 3 and 4). A detailed description of the virtual storage device 250 and 450 is provided below. The control layer 150 is coupled to storage devices 160, which are similar to storage devices 240a-240d or 440a-440d (shown in FIGS. 2 and 4, respectively) as described below. Detailed descriptions of the operation between the control layer 150 and the storage devices 160 are provided below.

The application system 110 may be coupled to the operating systems 120, file system 130, virtualization layer 140 and/or the control layer 150. The operating system 120 may include the file system 130, and be coupled to the virtualization layer 140 and/or the control layer 150. The file system 130 may be coupled to the virtualization layer 140 and/or the control layer 150.

The system 100 can be, for example, a direct attached storage (DAS) system, storage area network (SAN) system, network attached storage (NAS) system or other system. In some embodiments, the system 100 can be applied to a storage subsystem controller, a RAID controller or a host bus adapter, for example. The application program 110 can be, for example, a data base management system (DBMS), e-mail system or other application program. The operating system 120 can be, for example, MS-Windows™, MAC_OS™, Unix™, Solaris™, or other operating system. The file system 130 can be New Technology File System (NTFS), FAT32 file system, virtual file system (VFS), FS file system or other file system, for example.

In some embodiments, the virtual disks or volumes of the virtualization layer 140 are accessed by the application system 110, the operating system 120 and/or the file system 130 as if they were physical storage devices or volumes. The virtualization layer 140 may comprise the virtualization storage device 250 or 450 (shown in FIGS. 3 and 4).

In some embodiments, the application system 110 can be configured within a host system 210 (shown in FIG. 2) to access the storage devices 160. The operating system 120 runs in the host 210, and the file system 130 and the virtualization layer 140 may be configured within a data storage system 220 (shown in FIG. 2) to access the storage devices 160. In still other embodiments, the application system 110, the operating system 120 and/or the file system 130 are configured within the host system 210 to access the storage devices 160; and the virtualization layer 140 is configured within the data storage system 220 to access the storage devices 160.

FIG. 2 is a schematic block diagram of an exemplary computer system. The computer system 200 comprises a host system 210, a data storage system 220 and a host interface controller 215. The host system 210 may be, for example, a processor, stand-alone personal computer (PC), server or other system that is configured therein to access data stored within a data storage system. The data storage system 220 is coupled to the host system 210 via, for example, a local bus, network connection, interconnect fabric, communication channel, wireless link, or other means that is configured therebetween to transmit and receive data stored within the data storage system 220. In some embodiments, a plurality of host systems 210 are coupled and configured to communicate with the data storage systems 220.

In some embodiments, the host interface controller 215 is coupled between the host system 210 and the data storage system 220.

The data storage system 220 comprises at least one storage controller 230, such as the peripheral interface controller 230a-230d, and at least one storage device, such as storage devices 240a-240d. The storage devices 240a-240d are coupled to the storage controller 230. Each of the storage devices 240a-240d includes, for example, a storage disk or an array of disks. In some embodiments, a plurality of peripheral interface controllers 230a-230d are coupled to respective storage devices 240a-240d so that each of the peripheral controllers 230a-230d may desirably transmit data to the corresponding storage device and receive data therefrom. Detailed descriptions of operations between the storage controller 230 and the storage devices 240a-240d are provided below. Though FIG. 2 shows four storage devices 240a-240d, the data storage system 220 may comprise fewer or more storage devices. One of ordinary skill in the art can readily select the number of storages devices to form a desired storage system.

FIG. 3 is a schematic drawing showing an exemplary method for expanding the capacity of a virtual storage device.

Referring to FIG. 3, each of the storage devices 240a -240c comprises a plurality of blocks 242a-242c, respectively, for storing data mapped from a virtual storage device 250. The storage controller 230 (shown in FIG. 2) may emulate the virtual storage device 250, which has a plurality of block units 252 for storing data that are to be accessed by the host system 210 (shown in FIG. 2). The virtual storage device 250 is generated, for example, by the storage controller 230 by grouping the storage devices 240a and 240b. In some embodiments, the storage devices 240a and 240b have the same storage capacity. The capacity of the virtual storage device 250 corresponding to two physical storage devices 240a, 240b is equal to twice the capacity of either storage device 240a or 240b. In some embodiments, the storage device 240a, for example, is a storage device array, comprising N storage devices. The capacity of the virtual storage device 250 has N times the capacity of a single device. Detailed descriptions are provided with reference to FIGS. 4A-4B.

The storage controller 230 (shown in FIG. 2) then sequentially maps the data a0-an stored in the blocks 252 of the virtual storage device 250 to the blocks 242a and 242b of the storage devices 240a and 240b, respectively. In some embodiments, the storage controller 230 does not start mapping the data a0-an stored in the blocks 252 of the virtual storage device 250 to the blocks 242b of the storage device 240b until all of the blocks 242a of the storage device 240a are mapped to the data a0-an stored within the virtual storage device 250. In short, the mapping of data a0-an to the storage device 240a is accomplished and then the mapping of the data to the storage device 240b is performed.

In some embodiments, the storage controller 230 sequentially maps the same data, e.g., a0-an, stored in the blocks 252 of the virtual storage device 250 to the blocks 242a and 242b of the storage devices 240a and 240b, respectively, as shown in FIG. 3. In these embodiments, either the storage device 240a or 240b stores parity data to repair the other storage device 240a or 240b if part or all of one of the storage devices 240a and 240b fails. For example, if the storage device 240b fails, the data stored within the storage device 240a can be mapped to the storage device 240b by the storage controller 230, while the virtual storage device 250 is accessed by the host system 210 (shown in FIG. 2). Thus, the storage devices 240a and 240b form a redundant array of inexpensive disks 1 (RAID 1) or mirrored disks.

Referring again to FIG. 3, the storage controller 230 (shown in FIG. 2) expands the capacity of the virtual storage device 250 by adding a storage device 240c. The block units 242c of the storage device 240c may be formatted by, for example, the storage controller 230 with 0 or 1. In some embodiments, the storage device 240c comprises an even parity if 0 is formatted into each block 242c of the storage device 240c, or an odd parity if 1 is formatted into each block 242c of the storage device 240c. The even or odd parity is provided for error detection by adding a parity bit. The parity bit indicates whether the number of 1 bits in the data mapped from the virtual storage device 250 was even or odd. If a single bit is changed during mapping, the parity is thus changed and error can be detected by such a change.

As described above, the storage device 240a and 240b are in RAID 1 format, and either the storage device 240a or 240b provides parity function. Further, the storage device 240c is initialized to nulls, such as 0 or 1, and the even or odd parity added to the storage device 240c is consistent with the nulls, respectively. Therefore, if the storage device 240c is added to the group of the storage devices 240a and 240b, the capacity of the virtual storage device 250 is expanded by the capacity of the storage device 240c. Unlike a traditional expansion of RAID storage devices, the exemplary method for expanding a storage system can be achieved without initialization or reconfiguration. The virtual storage device 250 can be accessed by the host system 210 (shown in FIG. 2) prior, during and after the capacity expansion of the virtual storage device 250 or the group of the storage devices 240a and 240b. The expanded capacity of the virtual storage device 250 contributed from the expansive storage device 240c is available to the host system 210 after a bitmap associated with the expanded virtual storage device 250 is created by, for example, the storage controller 230. The time required to generate the bitmap is in the order of seconds. After the capacity expansion of the virtual storage device 250, data “b0-bn” are sequentially mapped to the blocks of the storage device 240c and accessed by the host system 210.

Further, the system 200 is fault resilient. The host system 210 (shown in FIG. 2) will access the virtual storage device 250, rather than the storage devices 240a and 240b. If one or more, up to a redundancy level, of the storage devices 240a and 240b partially or totally fails, the host system 210 can still access correct data stored in the virtual storage device 250.

FIGS. 4A-4B are schematic drawings illustrating another exemplary method for expanding a capacity of a virtual storage device. Except for the storage device 420d, like items of the structure in FIGS. 4A and 4B, which are analogous items of the structure in FIG. 3, are identified by reference numerals that are increased by 200.

FIG. 4A is a schematic drawing showing an exemplary configuration of an array of storage devices. In some embodiments, the storage controller 230 (shown in FIG. 2) emulates the virtual storage device 450 by grouping the storage devices 420a, 420b and 420d. The storage devices 420a and 420b are configured as an array by, for example, the storage controller 230 for storing the data mapped from the virtual storage device 450. The virtual storage device 450 thus has a capacity equal to the sum of the capacities of the storage devices 420a and 420b. In some embodiments, if the storage devices 420a and 420b have the same storage capacity, the capacity of the virtual storage device 450 is twice the capacity of either the storage device 420a or 420b. If the array includes N storage devices, the virtual storage device 450 has N times capacity of a single storage device.

The storage controller 230 (shown in FIG. 2) then sequentially maps the data a0-an and b0-bn stored in the blocks 452 of the virtual storage device 450 to the blocks 442a and 442b of the storage devices 440a and 440b, respectively. In some embodiments, the storage controller 230 does not start mapping the data b0-bn stored in the blocks 452 of the virtual storage devices to the blocks 442b of the storage device 440b until all of the blocks 442a of the storage device 440a are mapped with the data a0-an stored within the virtual storage device 450.

The storage controller 230 then stores a sum of data stored in corresponding blocks of the storage devices 440a and 440b into a corresponding block of the storage device 440d. For example, the sum, i.e. a0+b0, of the data “a0” stored in the block 442a(0) of the storage device 440a and the data “b0” stored in the block 442b(0) of the storage device 440b is stored into the block 442d(0) of the storage device 440d. This process ends until the sum “an+bn” is stored into the block 442d(n) of the storage device 440d. This process can be referred to as “linear span”.

The storage device 440d provides parity function. If, for example, the storage device 440a totally or partially fails, the storage controller 230 will use the storage devices 440b and 440d to recover the data stored in the storage device 440a. For example, the data “a0+b0” stored in the block 442d(0) of the storage device 440d minus the data “b0” stored in the block 442b(0) of the storage device 440b is equal to “a0”. The recovered data “a0” is then stored into the block 442a(0) of the storage device 440a or other corresponding block of a replacement. If N storage devices are configured for storing the data mapped from the virtual storage device 450, the linear span and recovering process set forth above can still be performed by the storage controller 230. In still other embodiments, the repair process can be performed by an exclusive-OR (XOR) process to recover the damaged storage device.

Referring to FIG. 4B, the storage controller 230 (shown in FIG. 2) expands the capacity of the virtual storage device 450 by adding an expansive storage device 440c. The block units 442c of the storage device 440c are formatted by the storage controller 230, for example, with 0 or 1. In some embodiments, the storage device 240c comprises an even parity if 0 is formatted into each block 442c of the storage device 440c, and an odd parity if 1 is formatted into each block 442c of the storage device 440c. The even or odd parity is for error detection by adding a parity bit.

As described above, the storage device 440d provides parity function for the array composed of the storage devices 440a and 440b or more. Further, the storage device 440c is initialized to nulls, such as 0 or 1, and the even or odd parity added to the storage device 440c is consistent with the nulls. Therefore, if the storage device 440c is added to the array of the storage devices 440a and 440b, the capacity of the virtual storage device 450 is expanded by the capacity of the storage device 440c. As set forth above, no need of array initialization or reconfiguration is required. The virtual storage device 450 can be accessed by the host system 210 (shown in FIG. 2) prior, during and after the capacity expansion of the virtual storage device 450 or the array of the storage devices 440a and 440b. The expanded capacity of the virtual storage device 450 contributed from the expansive storage device 440c is available to the host system 210 after a bitmap associated with the expanded virtual storage device 450 is created by, for example, the storage controller 230. The time of generating the bitmap is in the order of seconds.

After the capacity expansion of the virtual storage device 450, data “c0-cn” are sequentially mapped to the blocks 442c of the storage device 440c and accessed by the host system 210. Also, the system 200 is fault resilient. The host system 210 (shown in FIG. 2) will access the virtual storage device 450, rather than the array of the storage devices 440a and 440b. If one of the storage devices 440a and 440b partially or totally fails, the host system 210 can still access correct data stored in the virtual storage device 450.

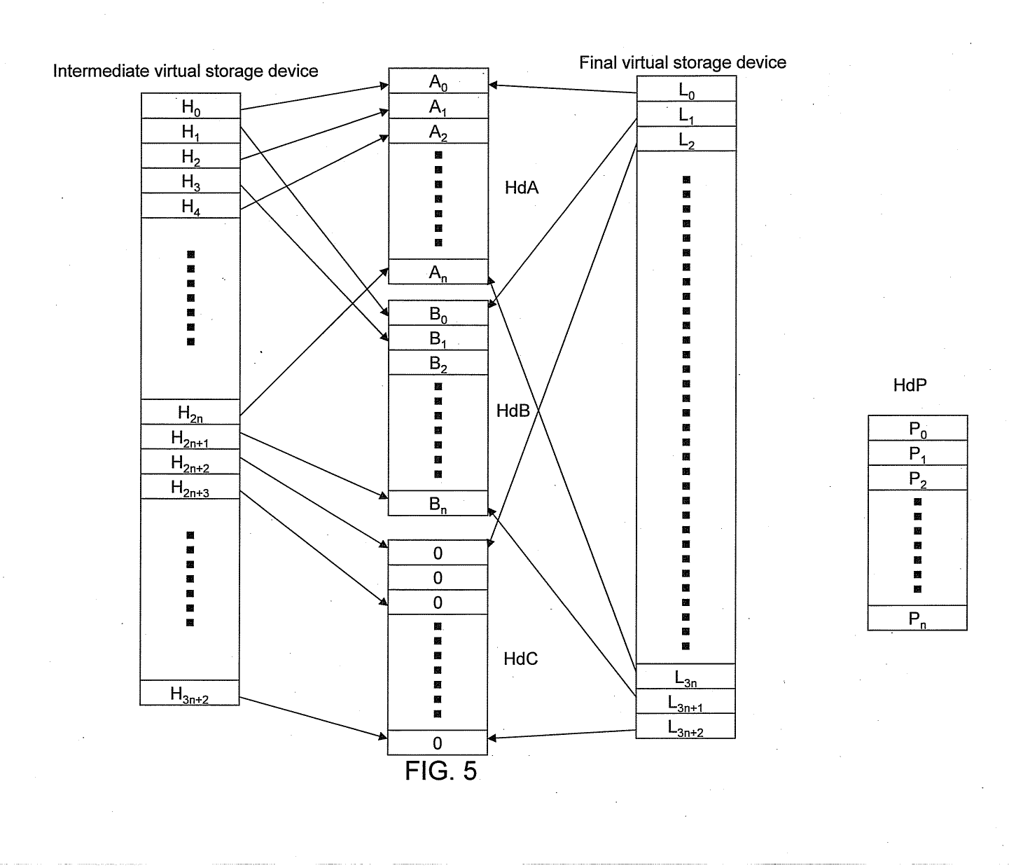

FIG. 5 is a schematic drawing showing another exemplary embodiment of a device type of the data storage system. In this figure the data H₀-H₂ₙ₊₁ and parity blocks P₀-Pₙ of an array of disks are depicted as a linear set of blocks in a rectangular form. The original virtual storage device may comprise three such regions, mapped on three physical disks (HdA, HdB and HdP). The user data H₀-H₂ₙ₊₁ stored in the first two regions are mapped across to the disks HdA and HdB as A₀-Aₙ and B₀-Bₙ, respectively, and the parity blocks (not labeled) are mapped to corresponding blocks P₀-Pₙ on the third disk HdP. The capacity of the original virtual storage device (not shown) is expanded, thereby yielding an intermediate virtual storage device, by adding a fourth region including segments (not labeled) with data H₂ₙ₊₂-H₃ₙ₊₂ on a fourth physical disk HdC having the same capacity of the disks HdA and HdB. The segments storing data H₂ₙ₊₂-H₃ₙ₊₂ are deemed as expansion of the original storage (including devices HdA and HdB) for mapping new data. This data mapping may only take in the order of seconds at most, and the intermediate virtual storage device (including the capacity of the devices HdA and HdB) can be accessed during the data mapping process. The intermediate virtual storage device (including the capacity of the devices HdA, HdB and HdC) will be available as soon the data mapping is complete. In some embodiments, the expanded capacity is immediately available. However, bandwidths of the added disk (i.e. HdC) are not efficiently utilized by those applications that benefit from striping of the data. A background processing step may reconfigure the intermediate storage system, thereby yielding a final storage system including data L₀-L₃ₙ₊₂. During this reconfiguration process, only the segment of the devices that is in transition is not available for update. The segments of the devices prior to the in-transition segment may be accessible by the reconfiguration of the intermediate virtual storage device. The segment after the in-transition segment may be accessed by the mapping of the intermediate virtual storage device. Once the reconfiguration of the last segment of the intermediate virtual storage device is completed, the intermediate virtual storage device may be eliminated and the final virtual storage device is in function.

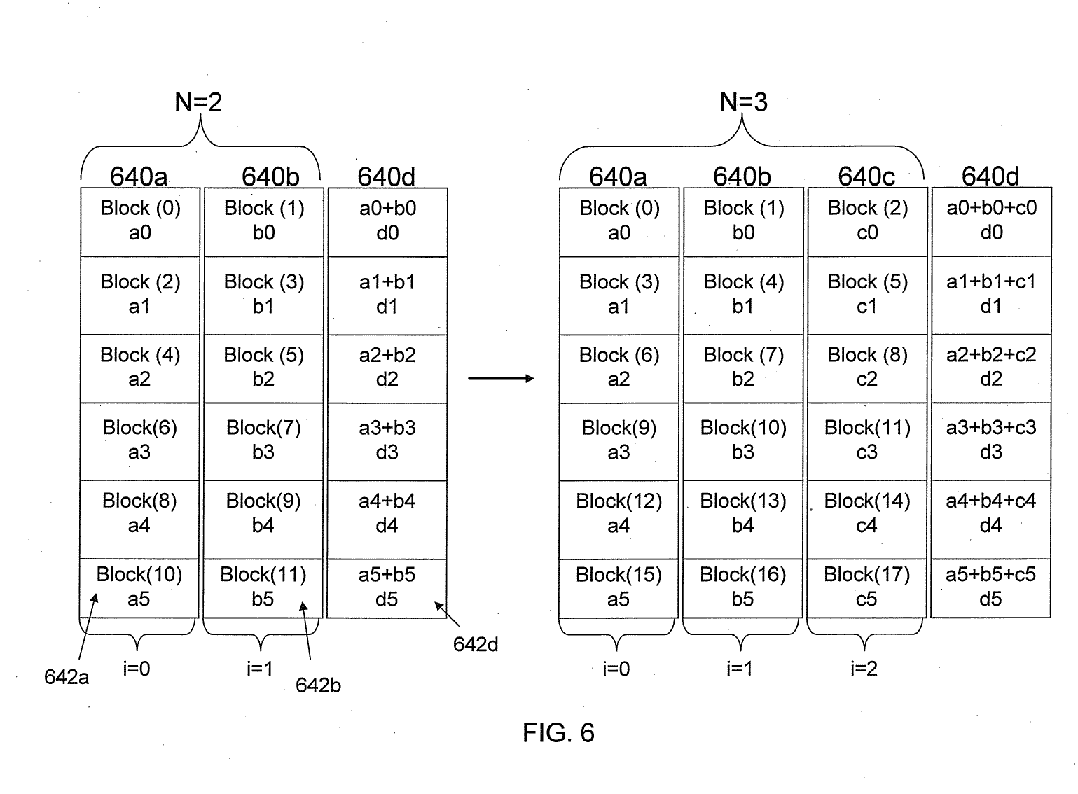

Referring to FIG. 6, the expansion from two storage devices, 640a, 640b, to three storage devices 640a, 640b, 640c as well as a method for updating a block address is now described. Storage devices 640a, 640b each include a plurality of data blocks 642a and 642b, respectively. Initially, data is sequentially mapped and stored into storage devices 640a and 640b. For example, block(0) is stored in block a0 of storage device 640a and block(1) is stored in block b0 of storage device 640b. The sum of data stored in corresponding blocks of storage devices 640a and 640b is stored in storage device 640d so that, for example, the data stored in block d0 is equal to sum of a0 and b0. As explained above, storage device 640d provides a parity function so that if, for example, storage device 640a totally or partially fails, the storage controller 230 (as shown in FIG. 2) will use the storage devices 640b and 640d to recover the data stored in storage device 640a by subtracting the value of data in 640b from the value of the data in 640d.

Once the data has been sequentially mapped in storage devices 640a and 640b, the location of a data block, k, may be given by the following formula:

k=N*m+i, where i=0, . . . , N−1

In the above equation, i represents the storage device number starting at zero (e.g., storage devices 640a, 640b), N equals the number of physical storage devices in the storage system and m equals the block number within a storage device. As illustrated in FIG. 6 where N=2, for example, data block(8) is stored in block a4 (m=4) of storage device 640a, which is storage device 0. Once third storage device 640c is added, the data is remapped and the associated bitmap is updated to identify the new location for all blocks affected by the move. To determine the new storage location for a storage block, block(k), the following equations are used to determine in which storage device, i, and data block, m, the data will be stored:

i=Rem(k/M), where M=N+L

m=k/M

In the above equation, L is the number of devices added to the existing number of devices, N, and Rem(k/M) is the remainder of division of k divided by M. For example, to determine the new location of block(8), which initially resides in block a4 of storage device 640a, M is calculated by adding the number of added storage devices, L=1, to the initial number of storage devices, N=2. Once M has been calculated, m is calculated by dividing the block number, k, by M. Since 3 divides into 8 twice leaving a remainder of 2, the new location of block(8) has been determined. The quotient of the division of k divided by M, 2, is equal to the block number, m, and the remainder of the division of k divided by M, 2, is equal to the storage device number, i. Therefore, the new location of block(8) will be block 2 (m=2) of storage device 640c (i=2), as illustrated in FIG. 6 where N=3.

Since i is greater than or equal to N, storage controller 230 (shown in FIG. 2) performs a read operation on the old address of block(8) (storage device 0, block 4) and writes block(8) to its new address (storage device 2, block 2). Storage controller 230 would then move the next block in the array, for example, block(9). However, if i is determined to be less than N, then storage controller 230 will determine the block number, k′, for the data block currently residing in the new address for block(k). Then storage controller 230 will read the data of block(k′) from the location and write the value of block(k) into the storage location. Then, storage controller 230 will determine the new address for data block(k′) using the same process it used to determine the new location of block(k). This entire process of moving the data blocks may be repeated until all data blocks needing to be moved have been moved.

This data mapping may take at most in the order of seconds, and in some embodiments, the expanded capacity is immediately available. During this reconfiguration process, only the segment of the devices that is in transition is not available for update. The segments of the devices prior to the in-transition segment may be accessible by the reconfiguration of the intermediate virtual storage device. The segment after the in-transition segment may be accessed by the mapping of the intermediate virtual storage device.

In addition to the above described embodiments, the present invention may be embodied in the form of computer-implemented processes and apparatus for practicing those processes. The present invention may also be embodied in the form of computer program code embodied in tangible media, such as floppy diskettes, read only memories (ROMs), CD-ROMs, hard drives, “ZIP™” high density disk drives, DVD-ROMs, flash memory drives, or any other computer-readable storage medium, wherein, when the computer program code is loaded into and executed by a computer, the computer becomes an apparatus for practicing the invention. The present invention may also be embodied in the form of computer program code, for example, whether stored in a storage medium, loaded into and/or executed by a computer, or transmitted over some transmission medium, such as over the electrical wiring or cabling, through fiber optics, or via electromagnetic radiation, wherein, when the computer program code is loaded into and executed by a computer, the computer becomes an apparatus for practicing the invention. When implemented on a general-purpose processor, the computer program code segments configure the processor to create specific logic circuits.

Although the present invention has been described in terms of exemplary embodiments, it is not limited thereto. Rather, the invention should be constructed broadly to include other variants and embodiments of the invention which may be made by those skilled in the field of this art without departing from the scope and range of equivalents of the invention.

What is claimed is:

1. A method for expanding the storage capacity of a storage device, comprising the steps of:
emulating a virtual storage device by grouping a first storage device and a second storage device;
storing data in a plurality of data blocks in the virtual storage device;
expanding the size of the virtual storage device by adding a third storage device; and
remapping the data stored in the first and second storage devices into the first, second and third storage devices by a method, the method including the steps of:
determining a new storage location in the virtual storage device for each of the data blocks stored in the first and second storage devices; and
updating a bitmap with the new location of the stored data.

2. The method of claim 1, wherein the step of remapping the data further includes the step of:
reading the data from a first storage location; and
storing the data to the new storage location.

3. The method of claim 1, wherein the step of storing data further includes the step of:
creating a bitmap based on the location of the stored data.

4. The method of claim 1, wherein the new storage location is based in part on the number of storage devices added to the virtual storage device.

5. The method of claim 1, wherein the step of adding a third storage device expands a virtual memory device from a RAID 1 configuration to a RAID 4 configuration.

6. The method of claim 1, further including the step of:
accessing the data stored in the virtual storage device by a host system while the data is being remapped.

7. A machine readable medium encoded with program code, wherein when the program code is executed by a processor, the processor performs a method comprising the steps of:
emulating a virtual storage device by grouping a first storage device and a second storage device;
storing data in a plurality of data blocks in the virtual storage device;
adding a third storage device having a third plurality of storage blocks; and
remapping the data stored in the first and second storage devices in the first, second and third storage devices by a method, the method including the steps of:
determining a new storage location in the virtual storage device for each of the data blocks stored in the first and second storage devices; and
updating a bitmap based on the location of the stored data.

8. The machine readable medium of claim 7, wherein the step of storing data further includes the steps of:
creating a bitmap based on the location of the stored data.

9. The machine readable medium of claim 7, wherein the step of remapping the data further includes the step of:
reading the data from a first storage location; and
storing the data to the new storage location.

10. The machine readable medium of claim 7, wherein the new storage location is based in part on the number of storage devices added to the virtual storage device.

11. The machine readable medium of claim 7, wherein the step of adding a third storage device expands a virtual memory device from a RAID 1 configuration to a RAID 4 configuration.

12. The machine readable medium of claim 7, further including the step of:
accessing the data stored in the virtual storage device by a host system while the data is being remapped.

13. A system, comprising:
a first storage device and a second storage device; and
a storage controller connected to the first and second storage devices, wherein the storage controller is configured to:
emulate a virtual storage device by grouping the first storage device and the second storage device, each of the first and second storage devices comprising a plurality of blocks for storing data;
expand a capacity of the virtual storage device by adding a third storage device to the first and second storage devices;
relocate the data from the first and second storage devices to the first, second and third storage devices; and
generate a bitmap based on the new location of the data.

14. The system of claim 13, wherein the first storage device and the second storage device are configured to form a redundant array of inexpensive disks 1 (RAID 1).

15. The system of claim 13, wherein the first, second and third storage devices are configured to form a redundant array of inexpensive disks 4 (RAID 4).

16. The system of claim 13, wherein the virtual storage device comprises N storage devices and the storage controller is further configured to:
sequentially map blocks of data on the virtual storage device to the blocks of the N storage devices, wherein the blocks of data stored in the virtual storage devices are not mapped to an ith (i≦N) storage device after blocks of an i-1th storage device are completely mapped.
